(19) United States
(12) Patent Application Publication
(10) Pub. No.: US 2007/0223242 A1
(43) Pub. Date: Sep. 27, 2007

(54) DURABLE WARNING LIGHT SYSTEM

(75) Inventors: Edward R. Blades, Northfield Twp., MI (US); Daniel E. Blades, Westland, MI (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Blades Tow Right

(21) Appl. No.: 11/690,664

(22) Filed: Mar. 23, 2007

Related U.S. Application Data
(60) Provisional application No. 60/785,218, filed on Mar. 23, 2006.

(51) Int. Cl. B60Q 1/26

(52) U.S. Cl. 362/542; 362/549

(57) ABSTRACT

A housing for a warning light system for mounting on a vehicle or trailer to provide warning light signals. The housing is made of a durable material having a high crush strength. The housing may include multiple modular components, each with light portals therein to provide customizable lengths. A trailer mount for a warning light housing assembly is also disclosed.

### REFERENCE TO RELATED APPLICATIONS

This application is a non-provisional application corresponding to U.S. Provisional Application No. 60/785,218, filed Mar. 23, 2006, and is entitled to the benefit of the filing date thereof for all subject matter commonly disclosed therein.

### FIELD OF THE DISCLOSURE

The present disclosure relates to warning light systems, and particularly to warning light housing assemblies, for mounting on vehicles and/or trailers, especially emergency and other public service vehicles and trailers. More specifically, this disclosure is focused on providing durable yet lightweight housing assemblies by utilizing specific lightweight materials, such as a polyethylene material, that encases the warning light systems protecting them from the elements and damage from exposure to incidental contact with flying debris, rocks, hail or other materials. The present disclosure also focuses on novel apparatuses and methods for the use of flexible warning light and other safety systems. Accordingly, the objects of the present disclosure include providing novel and improved apparatus and methods of a warning light system.

### BACKGROUND

Signal lights of the type used on emergency vehicles such as police cars, fire trucks, ambulances, and wreckers, have progressed from simple dome lights to elaborate light bars which include a variety of types of signals and special purpose lights. These light bars are capable of producing a variety of light signals in various colors and patterns, each such signal having a particular purpose or significance. These light bars include many varieties of stationary, rotating, and oscillating lights.

A particular problem with existing light bars has been protecting the various light devices from the elements and damage from exposure to incidental contact with flying debris, rocks, hail or other materials. Current designs utilize housing materials and designs that are subject to damage during use due to their fragile character. In order to accomplish the objective of 360° visibility of mounted warning light systems, existing housing is typically made with thin transparent materials that are subject to breakage in the field. This need for 360° visibility conflicts with the desire for warning light housing assemblies to be lightweight, yet durable. In addition, water, dirt, and road salt leaking into the warning light systems can damage the components. There is a need for a warning light housing assembly having a durable housing unit that is both lightweight and provides maximum 360° visibility of the lighting system. It further would be useful that such an apparatus could be flexibly mounted in various configurations to provide full usage where the use of warning light systems are desired.

There is also a need for a warning light system that could be mounted at or near the rear end of a trailer, such as a utility pole trailer. In particular, there is a need for a warning light system that can be operated by remote control. Currently, the attachment of a temporary warning light system requires the use of a long wiring system for a power and control source. It would be useful to have a warning light system that could be powered by batteries and controlled remotely.

### SUMMARY OF THE DISCLOSURE

Broadly, described here are durable yet lightweight housing assemblies for warning light systems and methods of assembling these apparatus for use on vehicles, such as by emergency and other public service vehicles, and trailers. In particular, the warning light housing assemblies described here may be used for permanently mounting on emergency vehicles such as police cars, fire trucks, ambulances, and wreckers. Generally, the housing assemblies materials have sufficient material strength to provide the desired durability of the units. The disclosed housing assemblies also provide 360° visibility. In some versions, the enhanced material strength results from the use of low-density polyethylene, so that the housing assemblies have sufficient crush strength to withstand the contact from flying debris, rocks, hail or other materials and elements. In some variations of the warning light systems disclosed herein, mounting assemblies are provided to facilitate temporary or permanent mounting on the end of trailers such as utility pole trailers. In some variations the warning light systems disclosed herein might be operated remotely with batteries without power or control cords or wires. The systems might also provide for flexibility in widths with the use of adjustable apparatus for attaching warning light systems and other safety devices such as, for example, mud flaps or warning flags.

### BRIEF DESCRIPTION OF THE SEVERAL VIEWS OF THE DRAWING

Embodiments or variations of the warning light systems are now described by way of example with reference to the accompanying drawings.

FIG. 1 is a top plan view of a polyethylene warning light housing assembly of the present disclosure.

FIG. 2 is a front plan view of the polyethylene warning light housing assembly of FIG. 1;

FIG. 3 is a side view of the polyethylene warning light housing assembly of FIGS. 1 and 2;

FIG. 4 is perspective view of the polyethylene warning light housing assembly of FIGS. 1-3;

FIG. 5 is a front plan view of a trailer mount for a warning light housing assembly of the present disclosure with a warning light housing assembly and an oscillating light secured to the trailer mount;

FIG. 6 is a front plan view of a trailer mount frame for a warning light housing assembly of the present disclosure;

FIG. 7 is a front plan view of a trailer mount of FIG. 5 with a warning light housing assembly and an oscillating light secured to the trailer mount and the trailer mount secured to a utility pole;

FIG. 8 is a side view of a trailer mount and warning light housing assembly with a plurality of lights secured to the trailer mount, as shown in FIG. 5;

FIG. 9 is a top view of a trailer mount and warning light housing assembly of the present disclosure;

FIG. 10 is a front plan view (from behind a trailer having the warning light housing assembly thereon) of an adjustable temporary mount variation of the warning light housing assembly of the present disclosure;

FIG. 11 is a front plan view of a center stable component of the temporary mount variation of the warning light housing assembly of FIG. 10;

FIG. 12 is a bottom plan view of the center stable component of the temporary mount variation of the warning light housing assembly of FIG. 10;

FIG. 13 is an end view of the center stable component of the temporary mount variation of the warning light housing assembly of FIG. 10;

FIG. 14 is a front plan view of a left slidable adjustable component of the temporary mount variation of the warning light housing assembly of FIG. 10;

FIG. 15 is a front plan view of a right slidable adjustable component of the temporary mount variation of the warning light housing assembly of FIG. 10;

FIG. 16 is an end front plan view of the slidable adjustable components of the temporary mount variation of the warning light housing assembly of FIG. 10;

FIG. 17 is a schematic diagram of a warning light housing assembly in electrical communication with retractable end lights of the temporary mount variation of the warning light housing assembly of FIG. 10; and

FIG. 18 is a front plan view of a hinged temporary mount variation of the warning light housing assembly of the present disclosure.

### DETAILED DESCRIPTION OF THE PREFERRED EMBODIMENTS

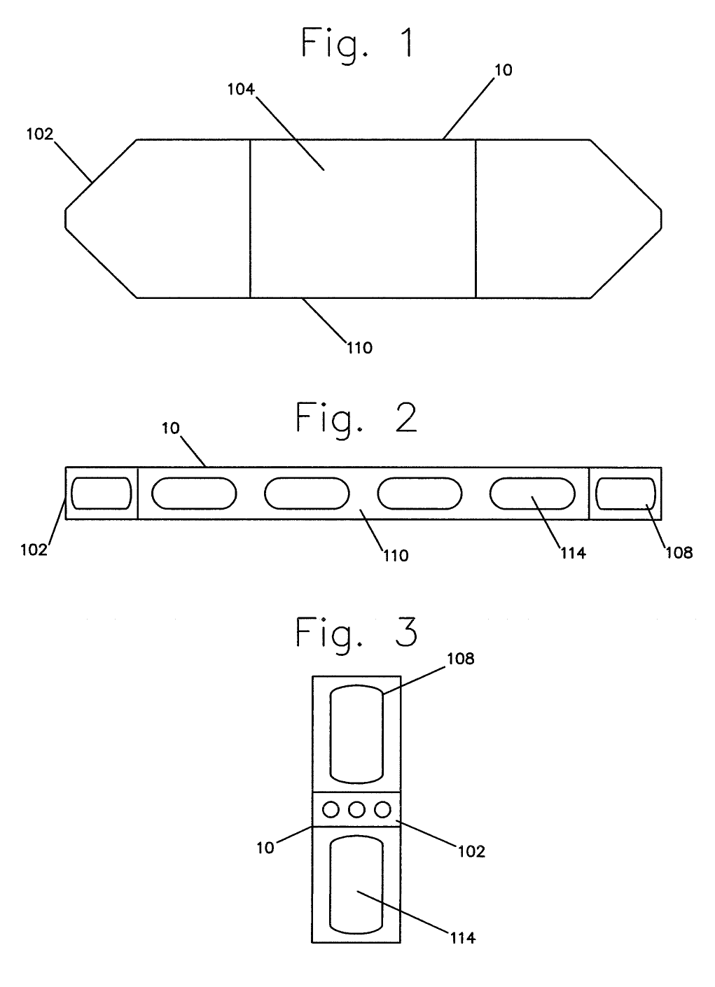

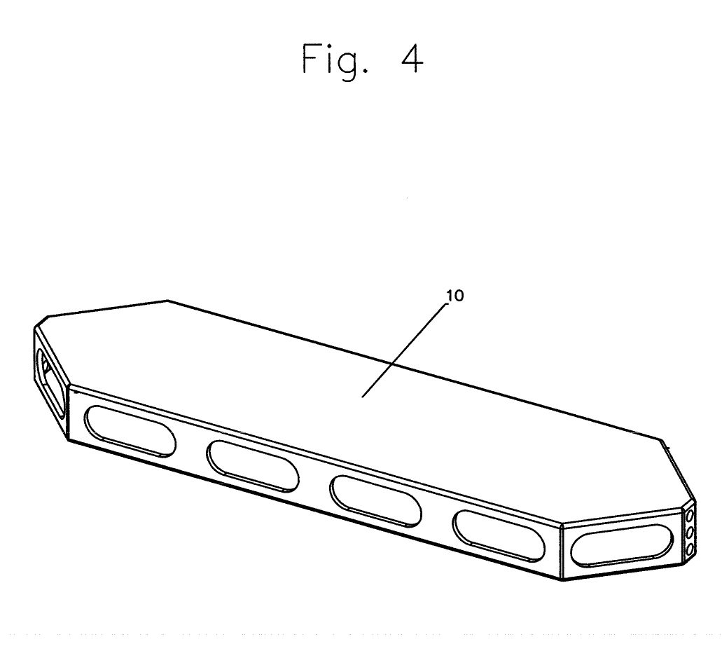

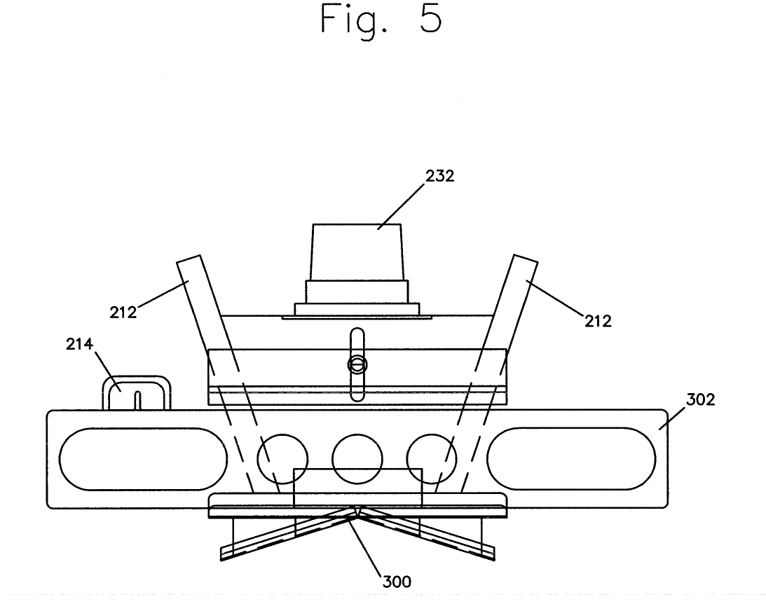

In the drawings, reference numeral 10 generally denotes an exemplary embodiment of a housing assembly design. FIGS. 1 to 3 illustrate various views of a preferred embodiment of the housing assembly design of the present disclosure for mounting on emergency vehicles such as police cars, fire trucks, ambulances, and wreckers. FIG. 4 is a front perspective view of a vehicle mountable warning light housing assembly.

The warning light housing assembly of the present disclosure makes use of durable materials combined with an effective design to withstand damaging shock from a source such as flying debris, rocks, hail or other materials and/or elements. The durability to withstand such shocks i.e. the crush strength of the warning light housing assembly, depends to a large extent on the unit material crush strength, which is a function of the composition, and to a lesser degree, the shape of the segment. The crush strength is defined as the force required to cause the housing assembly to crack or degrade in shape and/or function. In addition to withstanding damaging shock, the material would preferably resist the degrading effects of salt and other chemicals that are typically found on roadways and parking lots. The preferred material would be low-density polyethylene. Materials with appropriate crush strength include, but are not limited to, various metals, alloys, fiberglass, plastics such as polypropylene, polyethylene, or any combination of these materials. The descriptions of materials represent various versions of the housing assembly, and are not intended to limit the scope of the housing assembly materials.

The shape of the warning light housing assembly could vary and be of any shape that could provide the desired projection or illumination of the contained lighting systems. FIGS. 1 to 3 illustrate various perspectives of the preferred embodiment of the housing assembly design for mounting on emergency vehicles such as police cars, fire trucks, ambulances, and wreckers. FIG. 1 is a top plan view of the vehicle-mounted warning light housing assembly 10. The triangular shape at the distal ends 102 allow for 360° visibility of the contained lighting system. It is recognized that any shape could be utilized for the ends 102 that would allow for the desired 360° visibility, for example, rounded, oval, or octagonal. FIGS. 2 and 3 show a plurality of openings or light portals 108 for the placement of lights 114 at the distal ends 102 and along the elongated front and rear sides 110 of the vehicle-mounted warning light housing assembly 10. The length of the housing assembly may be adjusted through the insertion of one or more modular adjustment components 104 of various lengths, each having a front side and a rear side, so as to accommodate and provide any number of additional light portals 108. The modules might be bolted together using a plurality (for example, four to six) nuts and bolts or similar fasteners between the sides of the modules to hold the modules together. Alternately, a plate might be bolted between the bottoms of the modules. The plate might be utilized with the fasteners to give the light housing strength when it is mounted on a vehicle. In one variation the modules might be utilized in a temporary fashion by keeping them separated until their use is needed and then connecting the modules to achieve the desired length through the use of snap clips on the top of the modules and placing a strapping mechanism through a strapping holding mechanism (not shown) that would be affixed to the bottom of the modules. This strapping material could then be wrapped into the inside of the vehicle and clamped or might be attached to the sides of the roof of the vehicle through a clamp with a tightening mechanism.

The housing assembly would preferably utilize LED lighting, but could incorporate any lighting system currently in use as emergency warning systems, such as for example, incandescent lighting. The units could also be in any color desired without affecting the strength of the illumination. In some variations base plates used to mount the housing assembly 10 to a vehicle (not shown) made out of, by way of example only, aluminum, steel or plastic.

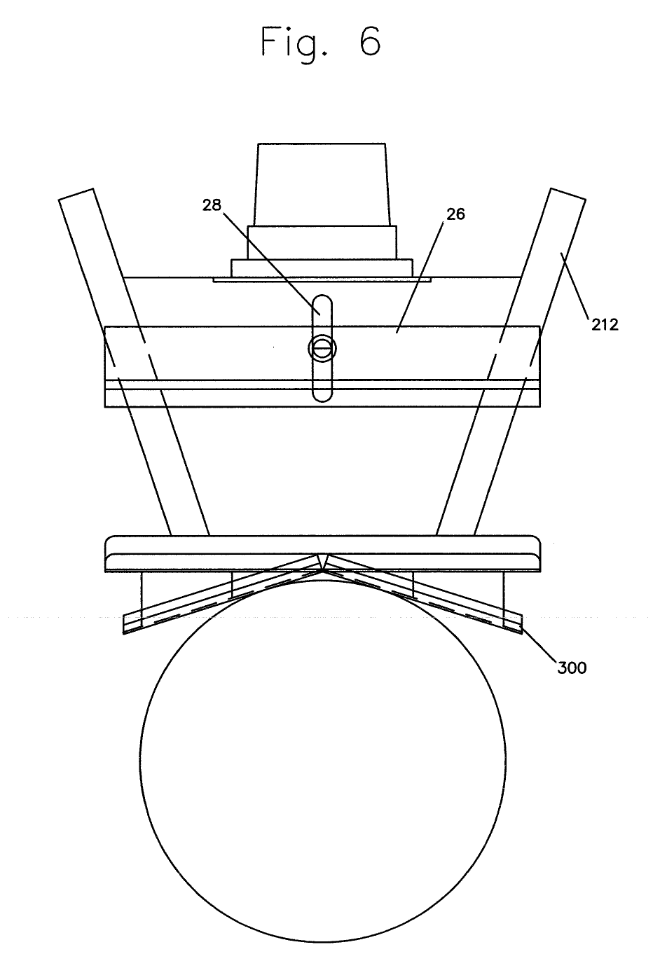

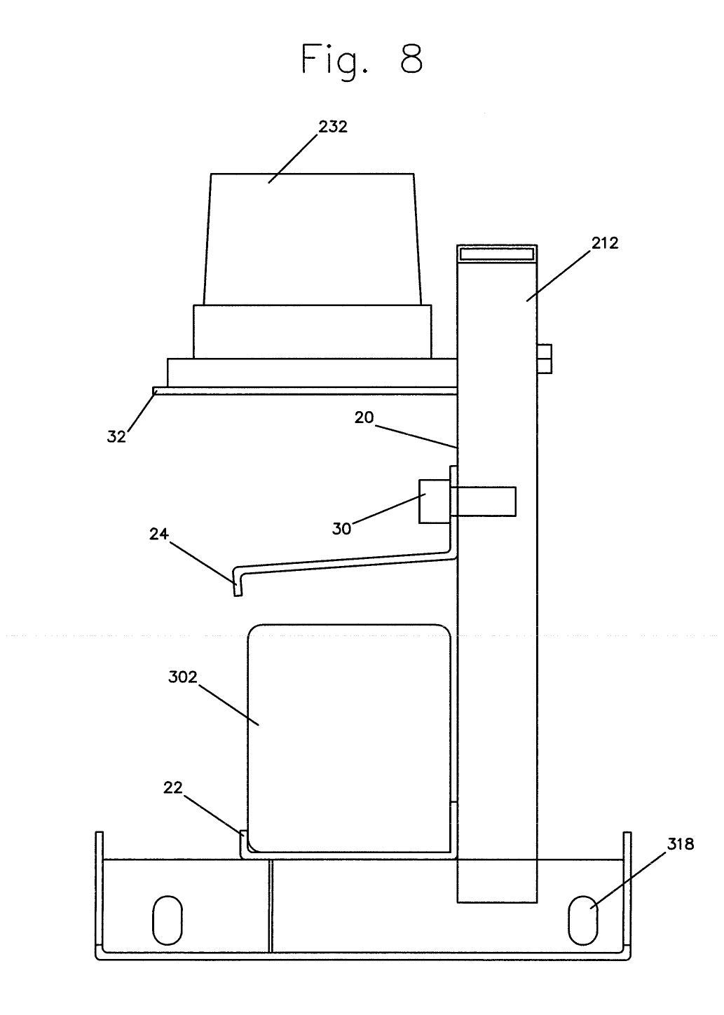

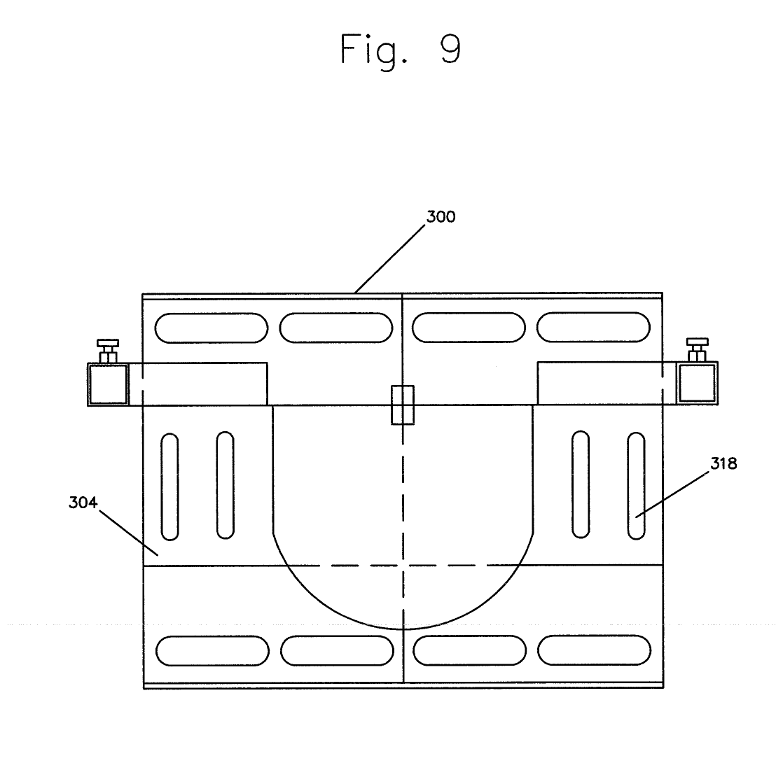

In an alternative embodiment, a warning light housing assembly of the present disclosure may be attached temporarily onto a long utility trailer such as a utility pole trailer. FIGS. 5 to 9 show one preferable variation of a mounting apparatus in the form of a trailer mount 300 for a warning light housing assembly 302. The trailer mount 300 could be attached to one of a utility pole 602 or trailer by an attachment mechanism such as a lag bolt through an opening 318 provided in a plate 304 at the bottom of the trailer mount 300.

In one variation, two warning flag holders 212 might be attached to a warning light housing bracket 20 of the trailer mount 300. Each of the warning flag holders 212 preferably extends at an acute angle from the vertical plane, tilted outwardly away from one another, to facilitate stowing, and retrieval of warning flags from, the warning flag holders 212. FIG. 5 shows a switch 214 for turning on the lights.

The warning light housing bracket 20 of the trailer mount 300 includes a lower mounting jaw 22 and an upper mounting jaw 24. The warning light housing assembly 302 is securely received between the upper and lower mounting jaws 22, 24. Preferably, the lower mounting jaw 22 is fixed relative to a vertical plate 26 of the warning light housing bracket 20. The vertical plate 26 includes an elongate vertical slot 28 therein, which can accommodate a fastener 30, such as a threaded bolt or pin, extending through the upper mounting jaw 24. Each of the upper and lower mounting jaws 22, 24 extends horizontally relative to the elongate vertical slot 28, and the upper and lower mounting jaws 22, 24 define a space therebetween for receiving the warning light housing assembly 302. When the warning light housing assembly 302 is placed along the lower mounting jaw 22, the upper mounting jaw 24 is brought down into engagement with a top surface of the warning light housing assembly 302, and the fastener 30 is tightened to secure the upper mounting jaw 24 to the vertical plate 26, thereby securing the warning light housing assembly 302 to the trailer mount 300.

In one variation the trailer mount 300 might hold an extra light 232 at the top of the warning light housing bracket, such as an oscillating light, in addition to the warning lights within the housing 302. FIGS. 5-9 are illustrative of one variation of this embodiment. However, there could be multiple ways of designing the warning light housing brackets. All of them would incorporate the use of a durable housing unit such as is described above for the housing assembly design for mounting on emergency vehicles.

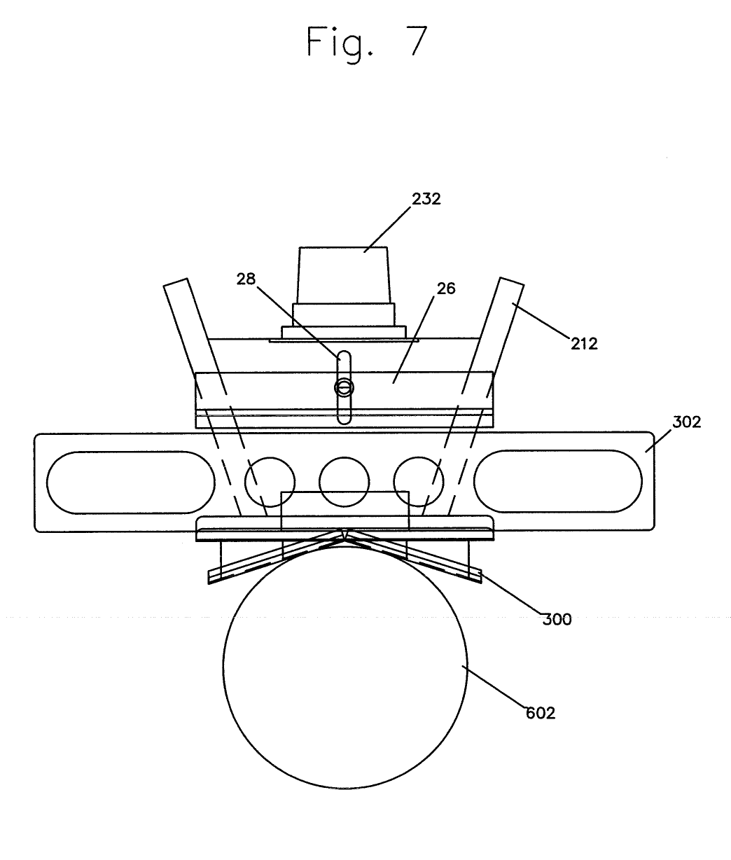

In one variation the warning light system of the present disclosure includes an integral battery housing 234 (see FIG. 7), powered by one or more batteries received in the battery housing, and may be controlled remotely without the use of a power cord or control cord.

In another alternative embodiment a warning light housing assembly could be utilized on a mounting apparatus that allows for an adjustable width dimension. This would be useful where safety equipment, such as, for example, mud flaps, might be needed on a temporary basis to be attached to a motor vehicle or trailer. The mounting apparatus might include a slidable bracket or brackets 506 to adjust the mud flaps (or other safety equipment) to a desired width. This mounting apparatus could be used as a temporary device on any motorized vehicle, trailer, heavy equipment, farm equipment, mobile home or any object that needed to be moved that required temporary vehicle safety products.

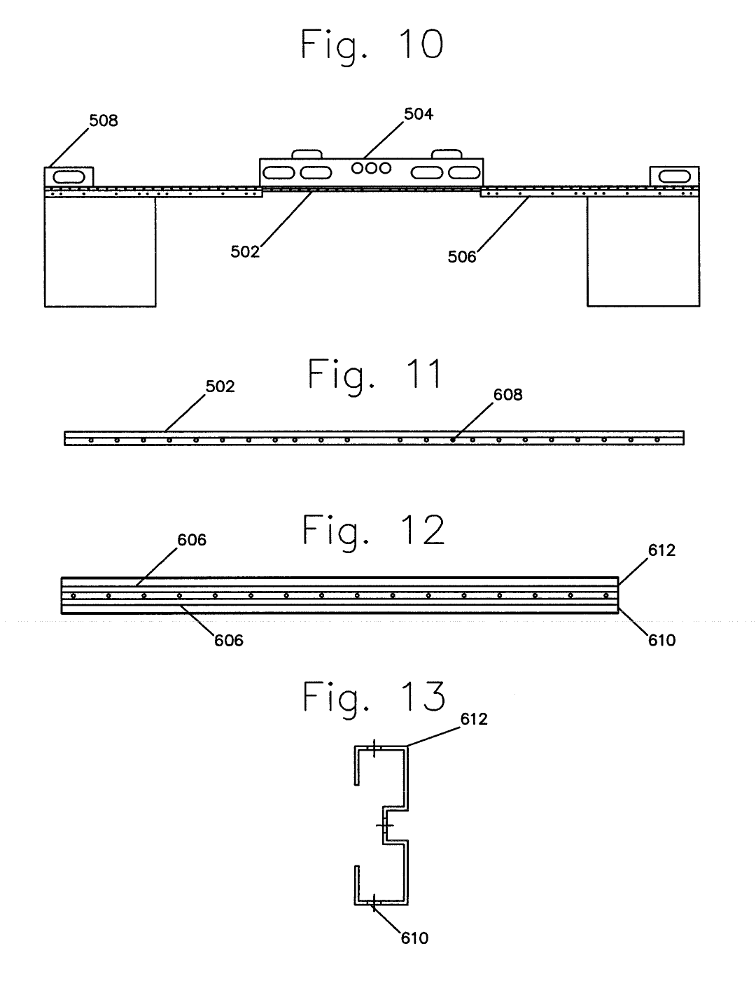

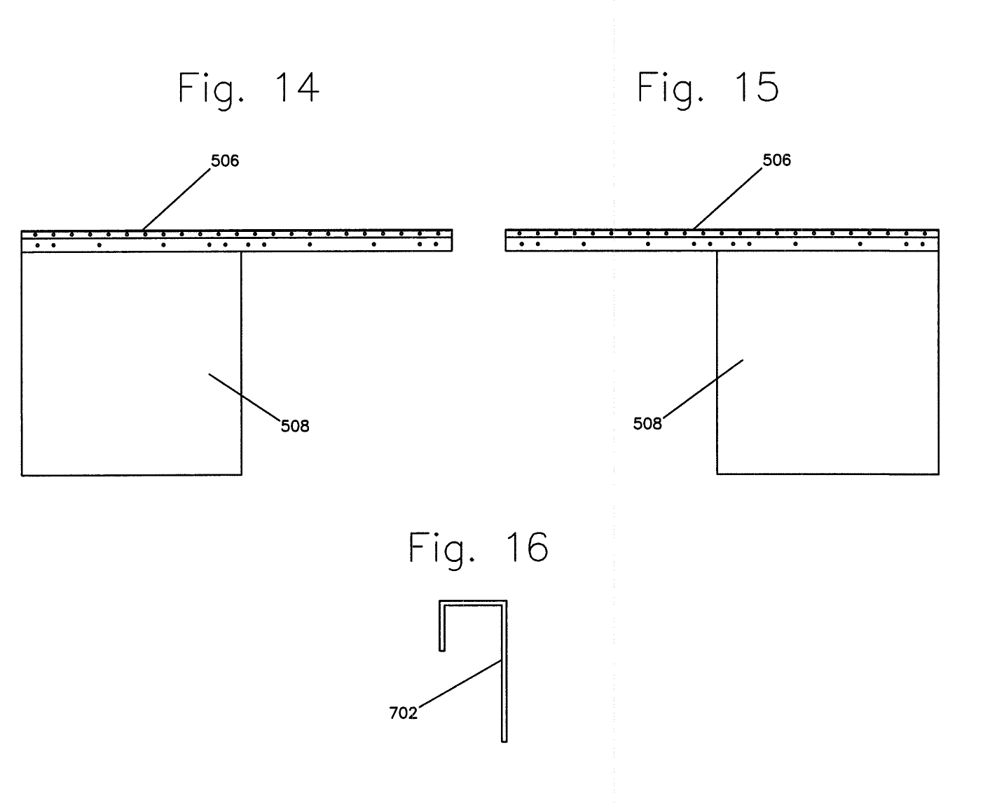

FIG. 10 shows one example of the mounting apparatus. The center component of the apparatus 502 is shown in more detail in FIGS. 11-16. FIG. 11 shows a front view of the center component that might be affixed to the vehicle or trailer itself, or might be affixed directly to the warning light housing assembly 504. It could be affixed in any way that would secure itself to the vehicle or trailer. FIG. 12 shows a bottom view that contains a rail support component 606 upon which the slidable brackets 506 shown in FIGS. 14-16 could be slid into and adjusted to various desired widths depending on the size of the vehicle or the trailer. FIG. 16 shows a side view of the component that contains a hook element 702 to allow it to slide into the center component's support rail 608. The mud flaps 508 might preferably be attached to an end of the slidable components 506. Once the desired width is achieved, the slidable brackets 506 are locked into position by inserting at least one pin or similar fastener for securing the slidable brackets 506 through respective one or more holes 510 and through one or more of the holes 608 in the center component 502. While the example shown discloses the slidable adjustable components sliding from the left towards the center in the front of the center component 610 and from the right towards the center in the back of the center component 612, any method of sliding or telescoping structure could be utilized to achieve an adjustable width.

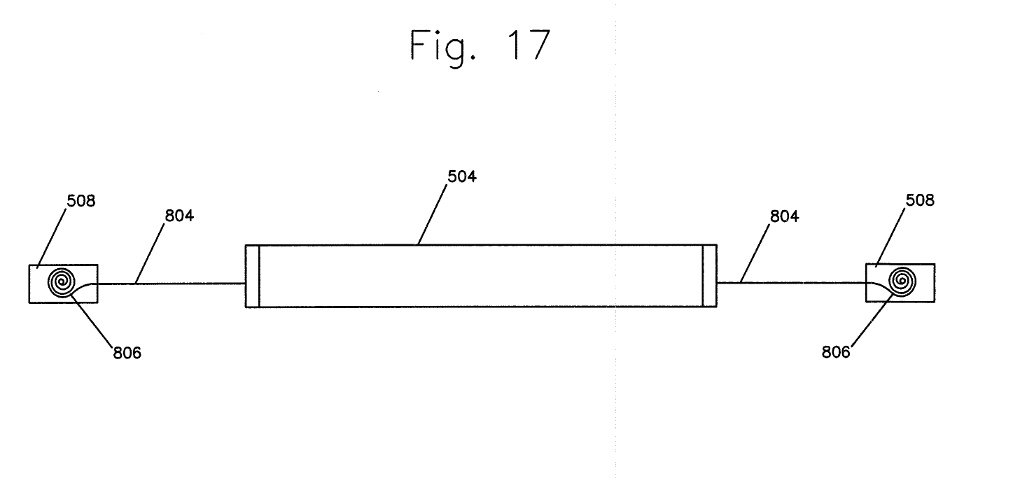

In one variation the mounting apparatus might also provide means for affixing an end light 508 at the end of the slidable component above each of the mud flaps so that the end lights 508 might also be slideable to a variety of widths, such as an aperture in a bracket adjacent each of the mud flaps received on the slidable components 506. In another variation the mounting apparatus might provide slots or other means for affixing warning flags 510 thereto. Thus, the mounting apparatus might accommodate one or more of the group of mud flaps, lights and flags. FIG. 17 is schematic diagram of a warning light housing assembly 504 in electrical communication with retractable end lights 508. Wires 804 establish the electrical communication between the warning light housing assembly 504 and the retractable end lights 508. Each of the wires 804 may be retracted through the use of a retractable coil 806. The retractable coils 806 prevent the wires 804 from becoming loose when the slidable brackets 506 are retracted.

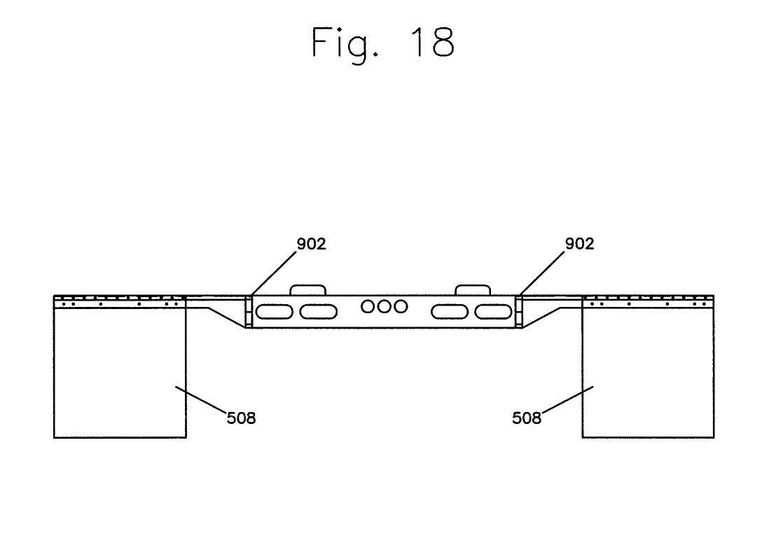

FIG. 18 shows an alternative embodiment of the mounting apparatus having mud flaps secured thereto, including a hinged bracket 902 that allows the mud flaps to swing out to a predetermined width and to be locked into place while in use.

Materials utilized for the adjustable apparatus could be steel, stainless steel, aluminum, plastic or any combination of materials.

While the fundamental features of the novel nature of the invention have been disclosed herein it should be understood that various aspects of the invention may be made by those skilled in the art without departing from the spirit and scope of the invention. Accordingly, all such modifications or variations are included in the scope of the invention as defined by the claims.

What is claimed is:

1. A warning light housing assembly for mounting on a vehicle to provide warning light signals, comprising:
a housing assembly adapted to be mounted on a vehicle or trailer;
said housing assembly containing a plurality of light portals therein;
said housing assembly containing a plurality warning lights visible through said light portals; and
said housing assembly constructed of at least one material selected from the group of metals, alloys, fiberglass, polypropylene, and polyethylene.

2. The warning light housing assembly of claim 1, wherein the housing assembly is constructed of low-density polyethylene.

3. The warning light housing assembly of claim 1, wherein the housing assembly includes a front side, a rear side, and triangular ends, and wherein the light portals are provided along the front side, the rear side, and in the triangular ends, providing 360° visibility of the warning lights.

4. The warning light housing assembly of claim 1, wherein the housing assembly includes one or more modular adjustment components, each of said modular adjustment components having a front side and a rear side having at least one light portal therein.

5. The warning light housing assembly of claim 1, wherein the housing assembly is remotely controlled and powered by a battery provided in the housing assembly.

6. A warning light housing assembly for mounting on a vehicle to provide warning light signals, the warning light housing assembly comprising:
one or more modular adjustment components, each of said modular adjustment components having a front side and a rear side having at least one light portal therein, and at least one warning light received in each of the modular adjustment components of the warning light housing assembly and visible through one or more of said at least one light portals.

7. The warning light housing assembly of claim 6, wherein the housing assembly is remotely controlled and powered by a battery provided in the housing assembly.

8. A mounting apparatus for a warning light housing assembly, comprising:
a bracket having a vertical plate with an elongate vertical slot therein;
a lower mounting jaw extending horizontally relative to the vertical slot and stationary relative to the vertical plate; and
an upper mounting jaw extending horizontally relative to the vertical slot and selectively securable to the vertical plate by a fastener received through the vertical slot, the lower mounting jaw and the upper mounting jaw defining a space therebetween to receive a warning light housing assembly.

9. The mounting apparatus of claim 8, further comprising a pair of warning flag holders secured to the bracket, each of the warning flag holders extending at an acute angle to a vertical plane.

10. The mounting apparatus of claim 8, further including a warning light housing assembly secured between the upper and lower mounting jaws containing a plurality of light portals therein, said housing assembly containing a plurality warning lights visible through said light portals, and said housing assembly constructed of at least one material selected from the group of metals, alloys, fiberglass, polypropylene, and polyethylene.

11. The mounting apparatus of claim 10, further including an oscillating light at a top of the bracket.

12. The mounting apparatus of claim 8, further comprising:
a rail support component;
a center component secured to the rail support component, said bracket defining the central component;
at least one slideable bracket slidingly and adjustably engaging the rail support component; and
the slideable bracket including means for securing at least one safety device thereto, said safety device selected from a group of a mud flap, a light and a warning flag.

13. The mounting apparatus of claim 12, wherein each of the at least one slidable brackets is locked into position by at least one fastener received through respective one or more holes in the slideable bracket and through one or more holes in the center component.

14. The mounting apparatus of claim 12, further comprising a warning light housing assembly securely received in the space between the lower mounting jaw and the upper mounting jaw, wherein the at least one safety device includes a light, and wherein the light is in electrical communication with the warning light housing assembly.

15. The mounting apparatus of claim 14, wherein the electrical communication between the light and the warning light housing assembly includes a retractable wire.

16. The mounting apparatus of claim 12, wherein the at least one safety device includes a mud flap, and wherein the slideable bracket includes a hinged bracket that allows the mud flaps to swing out to a predetermined width and to be locked into place while in use.

17. A method for mounting a safety device to a utility pole, comprising:
securing a bracket to a utility pole;
providing means for securing at least one safety device to the bracket, said safety device selected from a group of a mud flap, a light and a warning flag.

18. The method of claim 17, wherein the means for securing at least one safety device to the bracket includes securing a warning light housing assembly to the bracket, said housing assembly containing a plurality of light portals therein, a plurality warning lights visible through said light portals, and said housing assembly constructed of at least one material selected from the group of metals, alloys, fiberglass, polypropylene, and polyethylene.

19. The method of claim 18, wherein securing the warning light housing assembly to the bracket includes securing the warning light housing assembly between a lower mounting jaw secured to the bracket and an upper mounting jaw selectively secured to the bracket.

20. The method of claim 17, further comprising providing at least one slidable bracket in communication with the bracket to secure at least one of the safety devices at a selectable distance from the utility pole.
